(19) United States
(12) Patent Application Publication
(10) Pub. No.: US 2026/0229159 A1
(43) Pub. Date: Aug. 6, 2026

(54) METHOD AND DEVICE FOR REDUCING FLICKER FOR SUCCESSIVE PIXELS OF TEMPORALLY ALTERNATING COMPLEMENTARY COLORS

(71) Applicant: InterDigital CE Patent Holdings, SAS, Paris (FR)

(72) Inventors: Laurent BLONDE, THORIGNE-FOUILLARD (FR); Claire-Helene DEMARTY, MONTREUIL LE GAST (FR); Erik REINHARD, HEDE-BAZOUGES (FR); Olivier LE MEUR, TALENSAC (FR); Franck AUMONT, VERN SUR SEICHE (FR)

(21) Appl. No.: 19/141,910

(22) PCT Filed: Dec. 12, 2023
(86) PCT No.: PCT/EP2023/085302

§ 371 Date: Jun. 20, 2025

(30) Foreign Application Priority Data
Dec. 22, 2022 (EP) 22306994.9

(51) Int. Cl. G09G 3/20; G09G 3/3208

(52) U.S. Cl. CPC G09G 3/2074; G09G 3/3208; G09G 2300/0804; G09G 2310/0254; G09G 2320/0233; G09G 2320/0242; G09G 2320/0247; G09G 2320/0666; G09G 2330/023; G09G 2340/06; G09G 2360/16

(57) ABSTRACT

A method and device allow to reduce the energy needed for rendering an image by replacing a pixel of the image by temporally successive pixels of alternating complementary colors requiring less energy for display and selected according to a polarity constraint. This solution is exploiting the flicker fusion characteristic of the human vision system which allows to select complementary colors that might visually have the same perceptual characteristics than a corresponding single color. The alternating complementary colors are selected to be more frugal in terms of energy consumption required for rendering the color. The replacement is performed either by frame doubling, by frame skipping or by frame averaging. The notion of successive pixels is temporal. In other words, when using frame doubling, one pixel is replaced by two temporally successive pixels of alternating complementary colors pixels, the replacement pixels having half duration. When using frame skipping or averaging, two temporally successive pixels are replaced by two temporally successive pixels of alternating complementary colors pixels, the replacement pixels having the same duration. The polarity constraint allows to reduce the perceived flicker. The association between a color and the corresponding alternating complementary colors can be obtained from a look-up table. These principles may be used on an image or a video comprising a succession of images.

### CROSS-REFERENCE TO RELATED APPLICATIONS

This application claims the priority to European Application No 22306994.9 filed 22 Dec. 2022, which is incorporated herein by reference in their entirety.

### TECHNICAL FIELD

At least one of the present embodiments generally relates to energy consumption in display devices and more particularly to reduce the energy needed for rendering an image by replacing a pixel of the image by successive pixels of temporally alternating complementary colors selected according to a polarity constraint to reduce the perceived flicker.

### BACKGROUND

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and in the near future to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc.). Indeed, displays are the most important source of energy consumption for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

Organic Light Emitting Diode (OLED) is one example of display technology that is getting more and more popular because of numerous advantages compared to former technologies such as Thin-Film Transistor Liquid Crystal Displays (TFT-LCDs). Rather than using a uniform backlight, OLED displays are composed of individual LEDs as image pixels. OLED's energy consumption is therefore highly correlated to the image content and the energy consumption for a given input image can be estimated by considering the values of the displayed image pixels.

Although OLED displays consume energy in a more controllable and efficient manner, they are still the most important source of energy consumption in the video chain. Different techniques have been developed for reducing the energy needed to display images on a display device. Up to now, most of the solutions to the problem of reducing the energy of displaying some image pulses have targeted the modification of the colors of each frame of the pulses, by a small amount, in luminance and/or color. These solutions therefore limit the number of dimensions to be explored to find more energy-frugal images: for a pixel color, they propose another pixel color, limiting the search space dimensions to the three-color channels.

### SUMMARY

Embodiments described hereafter have been designed with the foregoing in mind and describe a method and device allowing to reduce the energy (i.e., power consumption) needed for rendering an image by replacing a pixel of the image by temporally successive pixels of alternating complementary colors requiring less energy for display and selected according to a polarity constraint. This solution is exploiting the flicker fusion characteristic of the human vision system which allows to select complementary colors that might visually have the same perceptual characteristics than a corresponding single color. The alternating complementary colors are selected to be more frugal in terms of energy consumption required for rendering the color. The replacement is performed either by frame doubling, by frame skipping or by frame averaging. The notion of successive pixels is temporal. In other words, when using frame doubling, one pixel is replaced by two temporally successive pixels of alternating complementary colors pixels, the replacement pixels having half duration. When using frame skipping or averaging, two temporally successive pixels are replaced by two temporally successive pixels of alternating complementary colors pixels, the replacement pixels having the same duration The polarity constraint allows to reduce the perceived flicker. The association between a color and the corresponding alternating complementary colors can be obtained from a look-up table. These principles may be used on an image or a video comprising a succession of images.

A first aspect is directed to a method comprising, comprising iterating over pixels of an image of a video, wherein an iteration comprises, for a pixel: obtaining a pair of alternating complementary colors based on the color of the pixel, replacing the pixel of the image of the video by a pair of temporally successive pixels based on polarity information, wherein when the polarity information has a first value, setting the color of the first temporally successive pixel to the first color of the pair of alternating complementary colors and setting the color of the second temporally successive pixel to the second color of the pair of alternating complementary colors, else setting the color of the first temporally successive pixel to the second color of the pair of alternating complementary colors and setting the color of the second temporally successive pixel to the first color of the pair of alternating complementary colors and inverting the polarity information for a next pixel.

A second aspect is directed to a device comprising one or more processors configured to iterate over pixels of an image of a video, wherein an iteration comprises, for a pixel: obtaining a pair of alternating complementary colors based on the color of the pixel, replacing the pixel of the image of the video by a pair of temporally successive pixels based on polarity information, wherein when the polarity information has a first value, setting the color of the first temporally successive pixel to the first color of the pair of alternating complementary colors and setting the color of the second temporally successive pixel to the second color of the pair of alternating complementary colors, else setting the color of the first temporally successive pixel to the second color of the pair of alternating complementary colors and setting the color of the second temporally successive pixel to the first color of the pair of alternating complementary colors and inverting the polarity information for a next pixel.

A third aspect of at least one embodiment is directed to a computer program comprising program code instructions executable by a processor, the computer program implementing at least the steps of a method according to the first aspect.

A fourth aspect of at least one embodiment is directed to a non-transitory computer readable medium comprising program code instructions executable by a processor, the computer program product implementing at least the steps of a method according to the first aspect.

### BRIEF DESCRIPTION OF THE DRAWINGS

FIG. 1 illustrates a block diagram of an example of display device in which various aspects and embodiments are implemented.

FIG. 2A illustrates the normalized response spectra of human cones (or spectral sensitivity functions).

FIG. 2B illustrates the temporal contrast sensitivity function for various adapting fields.

FIG. 2C illustrates the modulation sensitivity as a function of frequency for luminance and chromatic flicker.

FIG. 3 illustrates examples of decomposition of colors into alternating complementary colors according to embodiments.

FIG. 4 illustrates an example of process for reducing the energy consumption for a pixel of an image using alternating complementary colors according to embodiments.

FIG. 5 illustrates an example of process for establishing the pair candidates of alternating complementary colors according to a first embodiment.

FIG. 6 illustrates an example of process for establishing the pair candidates of alternating complementary colors according to a second embodiment in a color space providing color transforms and inverse color transforms.

FIG. 7 illustrates an example of pixel replacement by temporally successive pixels of alternating complementary colors according to an embodiment based on frame doubling.

FIG. 8 illustrates an example of pixel replacement by temporally successive pixels of alternating complementary colors according to an embodiment based on frame skipping.

FIG. 9 illustrates an example of pixel replacement by temporally successive pixels of alternating complementary colors according to an embodiment based on frame averaging.

FIG. 10 illustrates an example of process for generating a look-up table for alternating complementary colors according to embodiments and an example of process for modifying an image using the look-up table according to embodiments.

FIG. 11 illustrates two examples of deployment for the alternating complementary color process according to embodiments.

FIG. 12 illustrates examples of pixel replacement by alternating complementary color pixels according to variant embodiments based on frequency doubling and using opposed polarities for adjacent blocks.

FIG. 13 illustrates examples of blocks for pixel replacement by alternating complementary color pixels according to a variant embodiment using opposed polarities for adjacent blocks where the block size is non-homogeneous.

FIG. 14 illustrates an example of process for reducing the energy consumption for a pixel of an image using alternating complementary colors of opposed polarities according to embodiments.

### DETAILED DESCRIPTION

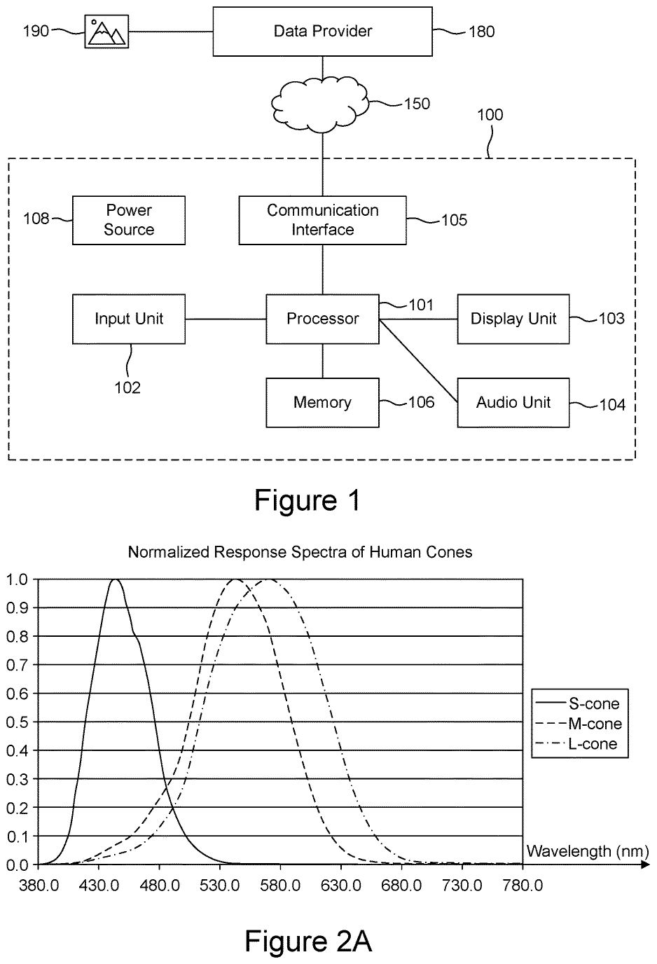

FIG. 1 illustrates a block diagram of an example of display device in which various aspects and embodiments are implemented. In the depicted environment, a user interacts with the display device 100 that is connected to a data provider 180 through a communication network 150.

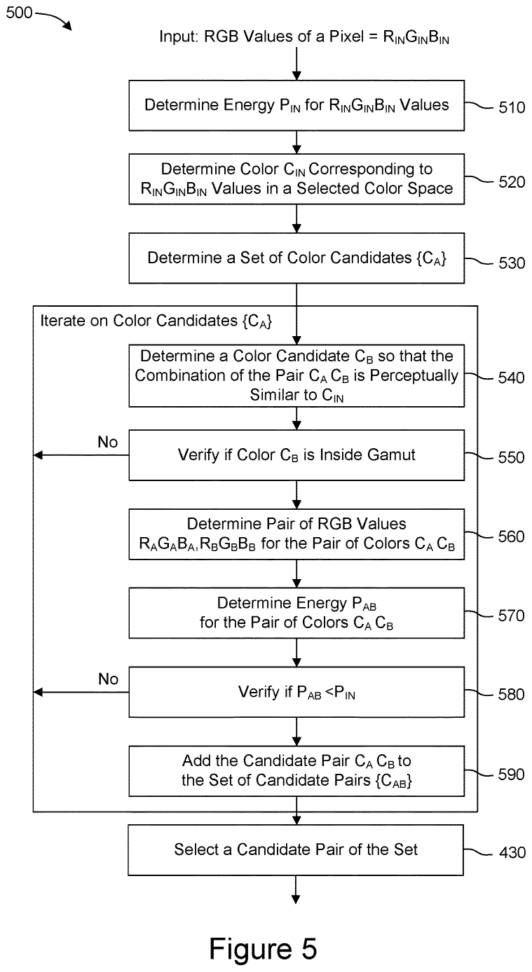

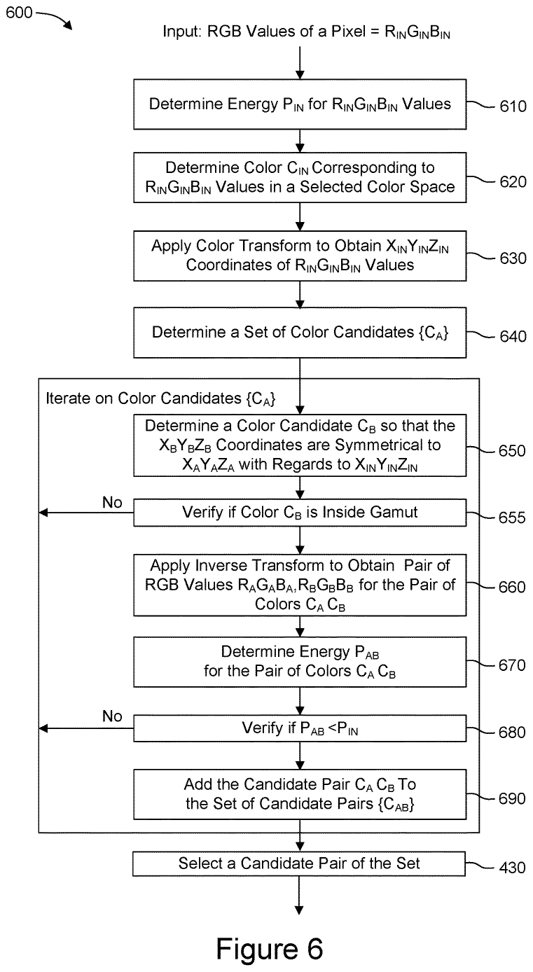

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the process 400 of FIG. 4, the process 500 of FIG. 5 or the process 600 of FIG. 6 and its related embodiment operating in a uniform color space.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication preferably uses a wireless communication standard to provide mobility of the display device, such as cellular (e.g. LTE) communications, Wi-Fi communications, and the like.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 may receive energy from the energy source 108 and may be configured to distribute and/or control the energy to the other components in the device 100. The energy source may be any suitable device for powering the device. As examples, the energy source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

Typical examples of display device 100 are smartphones, tablets, laptops, external monitors, head-mounted displays, television set, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure. In at least one embodiment, the device does not include a display unit but prepares data for display so that another device, such as a screen, can perform the display. Examples of such devices are set top boxes, media players, desktop computers, encoders, decoders, servers, computing grids, cloud computers, etc.

Embodiments below describe a method to modify an image light pulse for a color pixel while preserving as much as possible the visual similarity with the original light pulse and quality of experience and while reducing the energy needed to display the modified image pulse on a display device. More generally, embodiments are based on determining a pair of colors to replace the input color using a temporal modulation, wherein the average color of the pair of colors is perceptually similar/identical to the input color and the energy of the pair of colors is lower than twice the energy of the input color. The term “energy of the color” should be understood here as the energy needed for rendering a pixel of the color. Different types of temporal modulation are described: frequency doubling, frame skipping and frame averaging.

Compared to the state of art being selecting another color on a single frame consuming less energy, using pairs of colors has the advantage of versatility, the selection of colors of the pair being done based on two parameters: energy consumption and visual matching to the initial color. This method increases the search space for lower energy colors and therefore increases the probability to have a combination that reduces the energy more significantly.

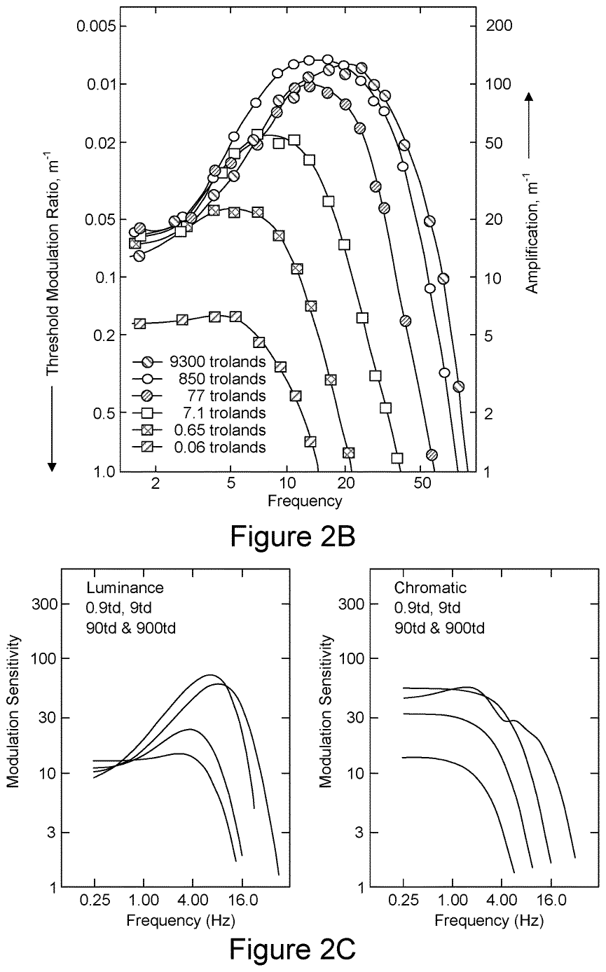

FIG. 2A illustrates the normalized response spectra of human cones (or spectral sensitivity functions). Electromagnetic radiation is characterized by its wavelength (or frequency) and its intensity. The range of wavelengths humans can perceive is approximately from 380 nm to 780 nm. When the wavelength is within this range, it is known as “visible light”. Perception of color is based upon the varying sensitivity of different cells in the retina (color receptors: cones and rods) to light of different wavelengths. Human observers have three types of color receptors, known as cone cells. This confers trichromatic color vision, cones being usually labeled either according to the wavelengths of the peaks of their spectral sensitivities: short (S), medium (M), and long (L), or simply according to the primary colors those peaks are centered on: Blue, Green, or Red as illustrated in FIG. 2A.

Trichromatic theory teaches us that the color a human observer perceives of a light spectrum can be characterized by 3 single scalar values. From a mathematical point a view, this initial step of human vision could be compared to that of a triple-kernel energy computation process. Let si(λ) be the wavelength response of a given light spectrum, and l(λ), m(λ), and s(λ) be respectively the spectral sensitivity functions of the L, M, and S cones, equation 1 below defines Li, Mi, and Si. These are the 3 scalar values that characterize the color of spectrum si(λ) seen by a human observer.

$${L}_{i} = {\int }_{- ∞}^{+ ∞} {s}_{i} ( λ ) \cdot l ( λ ) d λ \qquad ( 1 )$$

$${M}_{i} = {\int }_{- ∞}^{+ ∞} {s}_{i} ( λ ) \cdot m ( λ ) d λ$$

$${S}_{i} = {\int }_{- ∞}^{+ ∞} {s}_{i} ( λ ) \cdot s ( λ ) d λ$$

Although the spectrum of light arriving at the eye from a given direction determines the color sensation in that direction, there are many more possible spectral combinations that result in the same color sensations. In colorimetry, the term metamerism refers to the matching of a same apparent color of light signals with different spectral power distributions. Color spectra that match this way are called metameric spectra. Based on Equation (1), the mathematical definition of metamerism would be ∀λ∈ [symbol] :

$$∃ λ ∈ [ 380 , 780 ] \cdot {s}_{1} ( λ ) \neq {s}_{2} ( λ ) \qquad ( 2 a )$$

$${\int }_{- ∞}^{+ ∞} {s}_{1} ( λ ) \cdot l ( λ ) d λ = {\int }_{- ∞}^{+ ∞} {s}_{2} ( λ ) \cdot l ( λ ) d λ \qquad ( 2 b )$$

$${\int }_{- ∞}^{+ ∞} {s}_{1} ( λ ) \cdot m ( λ ) d λ = {\int }_{- ∞}^{+ ∞} {s}_{2} ( λ ) \cdot m ( λ ) d λ \qquad ( 2 c )$$

$${\int }_{- ∞}^{+ ∞} {s}_{1} ( λ ) \cdot s ( λ ) d λ = {\int }_{- ∞}^{+ ∞} {s}_{2} ( λ ) \cdot s ( λ ) d λ \qquad ( 2 d )$$

where s1(λ) and s2(λ) are the spectral responses of two metameric (yet different) spectra.

FIG. 2B illustrates the temporal contrast sensitivity function for various adapting fields. In the spatial domain, spatial vision can be characterized by the contrast sensitivity function (CSF). To thoroughly investigate the visual system to flicker, a Temporal Contrast Sensitivity Function (TSF) or a De Lange function can be plotted (De Lange, 1958). A TSF is a plot of how flicker varies with contrast and vice versa. In this figure, the area above the curve represents the area where no flicker is perceived by a human observer and the area below the curve represents the area where flicker is perceived. The eye appears to be most sensitive to a flicker frequency of 15 to 20 Hz at high luminances (photopic vision). At photopic light levels, less than 1% contrast is required to detect the stimulus and the high temporal frequency cut off is close to 60 Hz. At low light levels the maximum contrast is about 20% and the high temporal frequency cut off is approximately 15 Hz. To detect flicker of high frequencies, maximum contrast is required. Temporal resolution is not as efficient at low luminances (scotopic vision).

FIG. 2C illustrates the modulation sensitivity as a function of frequency for luminance and chromatic flicker. In this figure, the luminance levels are measured in trolands (td) that characterize retinal illuminance. This figure was obtained by a psychovision studies, in a typical application of Heterochromatic Flicker Photometry (HFP). The participants viewed a stimulus that alternated rapidly in time between two lights of different colors; the participant then had to adjust the intensity of one of the two lights (i.e., the amplitude of the light's spectrum) to minimize the sensation of flicker produced by the alternating lights. The figure on the left side is related to luminance flicker while the figure on the right side is related to chrominance flicker. HFP has long been the standard psychophysical method for finding equiluminant colors.

We use the principles illustrated in FIGS. 2A, 2B, 2C to determine a pair of colors that, when being temporally combined, are perceived by a human observer as another (single and stable) color. The technical effect used in the invention relies on temporal psychovisual modulation and the existence of a maximum cutoff frequency in the flicker sensitivity of human eye. Therefore, the high-level principle of the invention can be considered as adding a dimension to the image signal by temporally duplicating each pixel into two visually complementary temporally successive pixels and using this added dimension to minimize the pixel equivalent energy consumption. This principle is herein named alternating complementary colors (ACC). The two temporally successive pixels would be perceived by the user as a single pixel if the alternance between these pixels is faster than the flicker fusion frequency.

Normal flicker fusion frequency is about 50 Hz to 60 Hz and depends on retinal illumination. However, sensitivity to flicker in equiluminance situations is smaller (20 Hz to 30 Hz) than in situations where luminance varies between the two images of a pair. Then with the additional specific condition that the difference in luminance between two colors is small, flicker caused by the alternation of two colors is minimal. This equiluminant condition, mixed with the basic colors alternance configuration, can be used to limit the visibility of flicker.

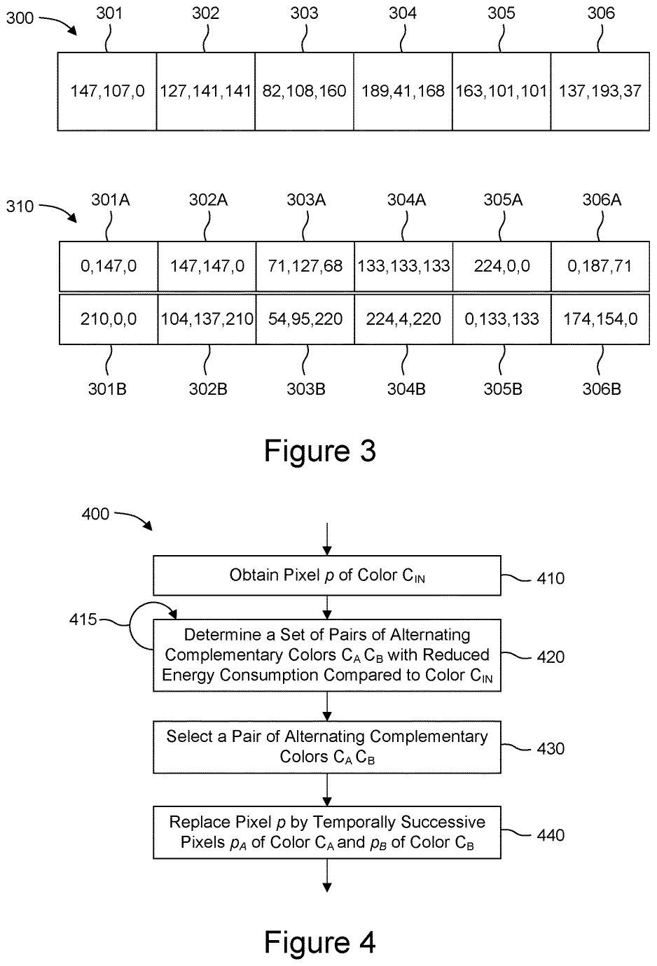

FIG. 3 illustrates examples of decomposition of colors into alternating complementary colors according to embodiments. In this figure, the line 300 shows a succession of pixels 301 to 306. The three numbers inside each block correspond to the color of the corresponding pixel, represented by RGB values expressed using an 8-bit depth. For example, the first pixel is defined by the following values for the color components of the pixel: 147 for red, 107 for green and 0 for blue. This results in a brown pixel. The colors of the other pixels are respectively medium grey for second pixel 302, navy blue for the third pixel 303, dark magenta for the fourth pixel 304, reddish brown for the fifth pixel 305, and bright green for the sixth pixel 306.

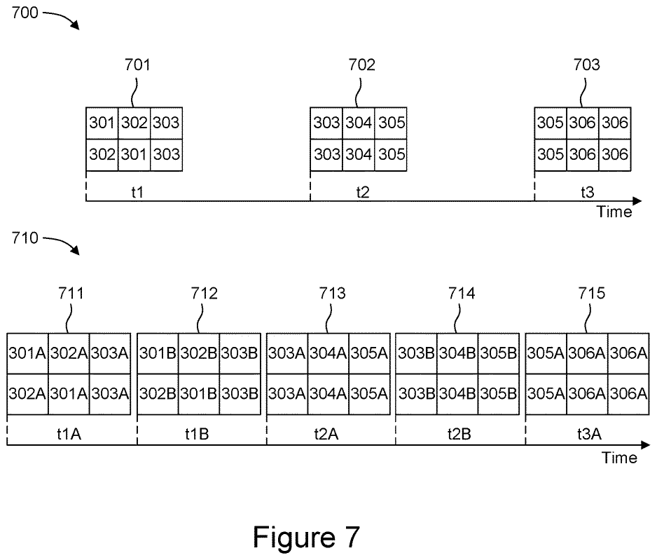

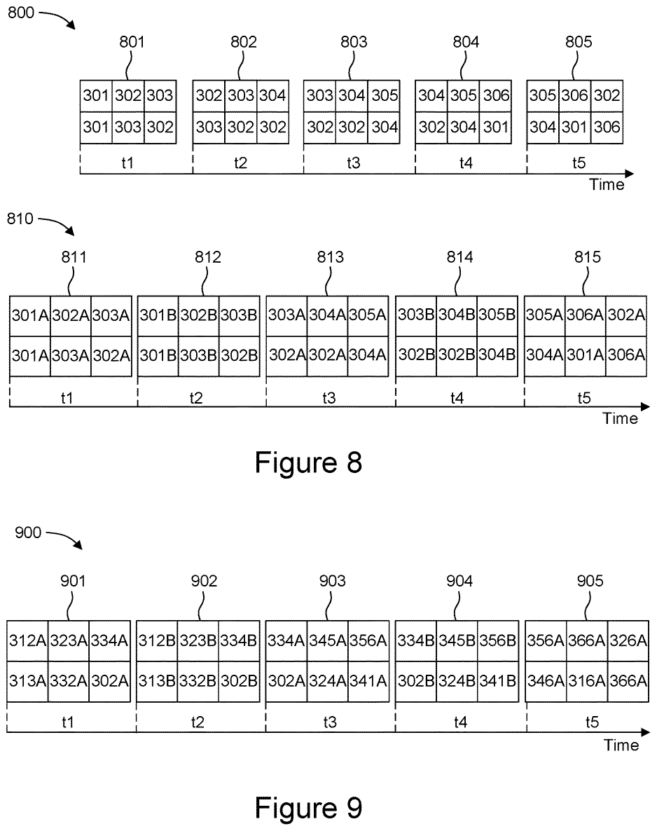

Line 310 shows a set of pairs of temporally successive pixels (301A, 301B) to (306A, 306B). These pairs of temporally successive pixels correspond to the alternating complementary colors that could be used to replace the original pixels 301 to 306. Similarly to line 300, the values inside the blocks represent the colors of the temporally successive pixels. In at least one embodiment, the temporally successive pixels are half the duration of the original pixels. In other words, a first image frequency (for instance 60 Hz) is doubled into a second image frequency (for instance 120 Hz) and an input image is decomposed into an output image pair displayed at the second image frequency. For example, the pixel 301 displayed in the input image at a frequency of 60 Hz could be replaced by the succession of the pixels 301A (green pixel) and 301B (red pixel) displayed at a global frequency of 120 Hz. The succession of the green and red pixels is perceived by a human observer as a brown pixel, thanks to the heterochromatic flicker fusion. A complete example is described below in relation with FIG. 7. In other embodiments, for example when doubling the display frequency is not possible, other techniques are used, such as frame skipping or frame averaging. Examples of such methods are described below in relation with FIGS. 8 and 9.

FIG. 4 illustrates an example of process for reducing the energy consumption for a pixel of an image using alternating complementary colors according to embodiments. The process 400 is for example implemented by a processor 101 of the device 100 of FIG. 1. In at least one embodiment, the process 400 is iterated over a set of colors comprising colors of all pixels of an input image. In another embodiment, the process 400 is iterated over a set of colors comprising all possible color values according to a selected color space. In other embodiments, the iteration is done over a subset of the pixels or a subset of the color space.

In step 410, the processor obtains the color c_{IN} of a pixel p.

In step 420, the processor determines a pair of alternating complementary colors c_{A}, c_{B} corresponding to the color c_{IN}. The pair of colors is selected based on two constraints. The first constraint is related to the quality of experience and ensures that a combination of temporally successive pixels p_{A} and p_{B} of color c_{A} and c_{B} is perceptually similar to the pixel p of color c_{IN}. The second constraint is related to the reduction of the energy required for display. In embodiments using frame doubling, it ensures that the energy required to display two temporally modulated half periods of temporally successive pixels p_{A} and p_{B} of colors c_{A} and c_{B} is lower than the energy required to display a period of the pixel p of color c_{IN}. In other embodiments using frame skipping or frame averaging, the second constraint is verified differently as further described below. The step 420 comprises selecting a first color c_{A} according to certain criteria described in further embodiments and then determining the appropriate second color c_{B} according to the similarity and energy reduction constraints. This results into the definition of a pair of colors corresponding to the input color c_{IN}. The step 420 is iterated multiple times (415) to determine a set of alternating complementary colors candidate pairs {C_{AB}}.

In step 430, the processor selects one of the candidate pairs C_{A}, C_{B} as the pair of colors of temporally successive pixels to replace the pixel of color C_{IN}, for example the candidate pair that has the lowest energy consumption.

In step 440, the processor replaces the pixel p of color C_{IN} by the two temporally successive pixels p_{A} and p_{B} of colors c_{A} and c_{B} according to one of the temporal modulation techniques presented herein.

With regards to color similarity, the verification of the first constraint is based on comparing the average of the pair of colors c_{A}, c_{B} to the color c_{IN}. The average of the color pair is computed in a display color space, in a standard color space or in a color space representative of human color vision. Examples of display color spaces are sRGB, AdobeRGB. Examples of standard color spaces (also known as measurement color spaces) are CIEXYZ, CIELUV. Examples of color spaces representative of human color vision (also known as uniform color spaces) are CIELab, IPT, OKLab, OSA-UCS. The resulting color of the display of the processed images with regards to the human perception is therefore the desired color as in the source images, whereas energy consumption is lessened thanks to the adequate choice of (c_{A}, c_{B}) color pair depending on a display color power model.

With regards to energy consumption, in embodiments using frame doubling, the verification of the second constraint is based on comparing the energy of the two temporally successive pixels p_{A} and p_{B} of colors c_{A} and c_{B} respectively to the pixel p of color c, where the duration of display of the temporally successive pixels p_{A} and p_{B} is half the duration of the pixel p. The energy as expressed throughout this document is based on a display color power model. A simple example of such model is based on the sum of the RGB pixel values to the power of a gamma, with gamma between 1.8 and 2.3, for example 2.2. For example, the pixel 302 of FIG. 3 whose RGB values are 127, 141, 141 would be represented by a color power value of (127^{2.2}+141^{2.2}+141^{2.2})=149480. The first pixel 302A of the temporally successive pixels whose RGB values are 147, 147, 0 would be represented by a color power value of ½×(147^{2.2}+147^{2.2}+0^{2.2})=29420. The second pixel 302B of the temporally successive pixels would be represented by a color power value of 103042. As illustrated in Table 1, the energy comparison would lead to the conclusion that it is more efficient to replace the pixel 302 (color power value of 149480) by the combination of the pair of temporally successive pixels 302A and 302B (combined color power value of 132462, thus lower).

TABLE 1

| Pixel | 302 | 302A | 302B | 302A + 302B |
|---|---|---|---|---|
| RGB values | 127, 141, 141 | 147, 147, 0 | 104, 137, 210 | 125, 142, 105 |
| Power Value | 149480 | 29420 | 103042 | 132462 |

In another embodiments using frame skipping, the second constraint related to energy consumption is verified by comparing the color power values of the original pixel and the skipped pixel by the determined pair of replacement pixels (302A and 302B as above).

In another embodiments using frame averaging, the second constraint related to energy consumption is verified by comparing the color power values of the two averaged pixels by the determined the pair of replacement pixels (302A and 302B as above) for the averaged pixels.

Colors presented to the human observer are defined by the display response to a RGB triplet, response defined for example within a sRGB or BT-709 or other display color space implemented in a display instance or model, with given parameter adjustments (brightness, contrast, color temperature, etc.). A color space {C} is chosen, in which color arithmetic operations are realized. A display, with colors represented in {C}, has a gamut {G} representing the complete subset of colors the display can render. For an image or video, each pixel color pulse C_{IN} is replaced by C_{A} and C_{B} sub-pulses so that visually the temporal combination of C_{A} and C_{B} gives C_{IN} color perception and the energy consumption of C_{A} and C_{B} is lower than the original consumption of C_{IN}.

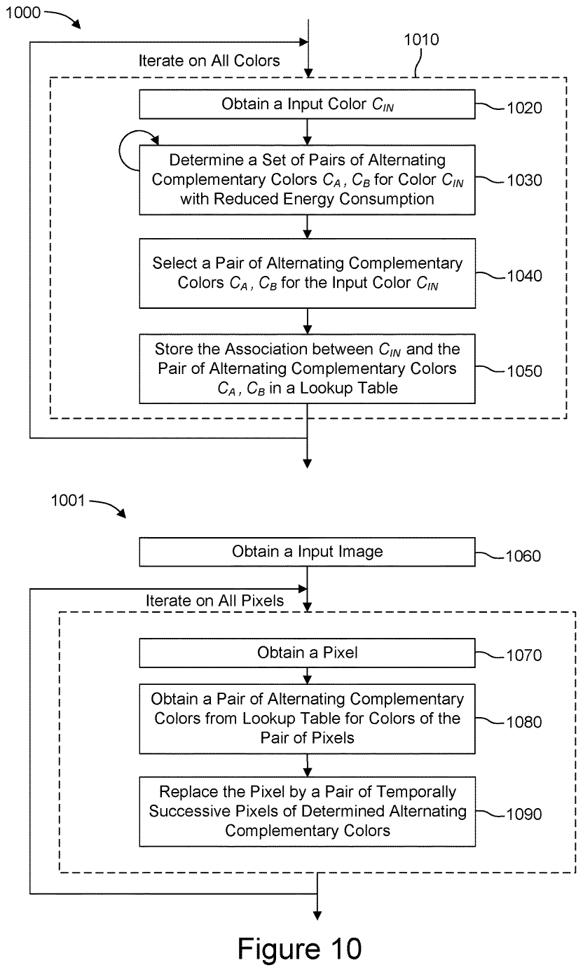

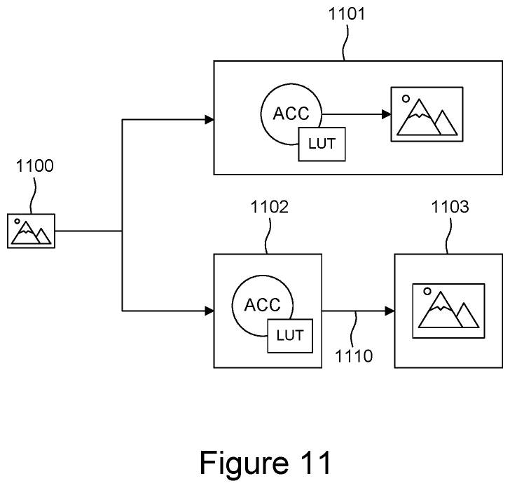

The iterations on step 420 lead to the creation of a set of temporally alternating complementary colors candidate pairs {C_{AB}}. From this set, a preferred candidate pair (for example the one with the lowest energy consumption) may be chosen for a given input, therefore creating an association between an input color and a pair of temporally alternating complementary colors. In at least one embodiment, this association is stored in a look-up table. This would prevent a display device to have to perform all iterations of steps 420 again for each image and would allow a faster implementation. Therefore, at least one embodiment comprises the steps 410, 420, 430, for example iterated over all possible colors of the gamut, therefore leading to the creation of a look-up table and another embodiment comprises only the steps 410, 430 and 440 iterated over all the pair of pixels of an input image to lead to a modified image that consumes less energy for display. Example embodiments are illustrated in FIGS. 10 and 11.

FIG. 5 illustrates an example of process for establishing the pair candidates of alternating complementary colors according to a first embodiment. The process 500 is for example implemented by a processor 101 of the device 100 of FIG. 1 and corresponds to the step 420 of FIG. 4. The process is operated on an input pixel p whose color is represented by the input color triplet R_{IN}G_{IN}B_{IN}. In step 510, the processor determines the energy consumption [symbol] _{IN} for the input color triplet according to a selected color power consumption model. The power consumption model is display dependent. For OLED displays, the power consumption model can follow the color model, including the RGBW case where a white LED supports the RGB LEDs for each physical pixel. A color model for a RGBW display is given by the Murdoch et al. in “Perfecting the color reproduction of RGBW OLED” proc. 30th International Congress of Imaging Science. This model can be extended with adequate parameters to represent per pixel power. In step 520, the processor determines the color point C_{IN} corresponding to the R_{IN}G_{IN}B_{IN} triplet within the gamut {G} of the color space {C}. The colors space for this figure is selected amongst a display color space, a standard color space, or a human vision color space. In step 530, the processor samples the color space {C} within the gamut {G} to determine a set of candidate colors {C_{A}} for the first pixel of the temporally successive pixels. Different criteria may be used to determine the sampling space. In at least one embodiment, a maximal color distance criterion is used to limit the sampling to the color space around C_{IN}. In various embodiments, the set of candidates comprises saturated colors, or greyscale colors (i.e., part of the grey ramp), or colors having the same luminance than C_{IN} or a combination of these colors. In at least one embodiment, all the color gamut space is explored and thus the set of candidates is the full set of possible values. In at least another embodiment, a subset of the color gamut space is chosen, for example using a smaller color resolution. In another embodiment, a number of randomly selected candidates are used.

The process is then iterated over the steps 540 to 590 to build the set of candidate colors pairs for each color of the set of candidate colors {C_{A}} for the first pixel of the temporally successive pixels. In step 540, the processor determines, for a selected color C_{A}, a second color C_{B} for the second pixel of the temporally successive pixels such that:

$${C}_{B} = 2 \cdot {C}_{IN} - {C}_{A} ,$$

or in another way, such that 2. C_{IN}=(C_{A}+C_{B}).

This ensures that the combination of temporally successive pixels of colors C_{A} and C_{B} will look similar to a pixel of color C_{IN} since C_{IN} is the average of colors C_{A} and C_{B} in the color space {C}. In step 550, the processor verifies that the color C_{B} is comprised in the gamut {G} of the color space {C}. Indeed, if the color is out of the gamut range, it cannot be displayed so that the combination of C_{A} and C_{B} sub-pulses will not be perceptually the same as a pulse of color C_{IN}. If the color is out of the gamut, the iteration stops for the selected value of C_{A} since it does not lead to a correct pair of colors for the temporally successive pixels. In this case, the process starts again the iteration with step 540 for the next value of C_{A} if any is remaining in the set.

In step 560, the processor determines the corresponding triplets R_{A}G_{A}B_{A}, R_{B}G_{B}B_{B} for the pair of colors C_{A}, C_{B}.

In step 570, the processor determines the energy consumption P_{AB} of the combination of pixels of colors C_{A}, C_{B}. Since the power consumption model of the display device is not necessarily known, the energy consumption for displaying a color can simply be approximated by the sum of its RGB values to the power gamma as illustrated in table 1. In embodiments using frame doubling, this is evaluated for half a period using the selected color power consumption model as:

$${𝒫}_{AB} = \frac{1}{2} 𝒫 ( {R}_{A} {G}_{A} {B}_{A} ) + \frac{1}{2} 𝒫 ( {R}_{B} {G}_{B} {B}_{B} )$$

In step 580, the processor verifies that [symbol] _{AB}< [symbol] _{IN}. Indeed, a candidate pair of colors for the temporally successive pixels is only considered when it brings some energy reduction. If it is not the case, then the candidate pair is discarded, and the process starts again the iteration with step 540 for the next value of C_{A} if any is remaining in the set. The test of step 580 can also be formulated as [symbol] _{A}+ [symbol] _{B}<2· [symbol] _{IN} with [symbol] _{A}, [symbol] _{B}, [symbol] _{IN} respectively representing the energy of a pixel of color C_{A}, C_{B}, C_{IN}. In other words, in embodiments using frame doubling, a candidate pair of alternating complementary colors is considered when the sum of the energies of the pair of alternating complementary colors is lower than twice the energy of the input color. In step 590, the processor adds the candidate pair C_{A}, C_{B} to the set of candidate pairs {C_{AB}}.

In step 430, the processor selects one of the candidate pairs C_{A}, C_{B} as the pair of colors of temporally successive pixels to replace the pixel of color C_{IN}. In at least one variant, the processor identifies in the list of the candidate pairs {C_{AB}} the position of the candidate pair that has the lowest energy consumption:

$$x min = arg min \{ \frac{1}{2} 𝒫 ( {R}_{A} {G}_{A} {B}_{A} ) + \frac{1}{2} 𝒫 ( {R}_{B} {G}_{B} {B}_{B} ) \}$$

As a result, the processor determines {C̅_̅{̅A̅}̅C̅_̅{̅B̅}̅}ₓₘᵢₙ as being the best replacement for C_{IN}. Replacing a pixel of color C_{IN} by two temporally successive pixels of color C_{Axmin} and C_{Bxmin}, each over a half period, will allow to reduce the energy consumption when displaying the pixel while keeping an excellent quality of experience since the temporally successive pixels will be perceived by a human observer as a single pixel of color C_{IN}.

In at least one embodiment, the correspondence between a color C_{IN} and its best color pair replacement C_{Axmin}, C_{Bxmin} is stored in a look-up table so that the subsequent modifications can be done very efficiently. Providing the input color to the look-up table would allow to get immediately the corresponding color pair without having to perform again the processes 400 of FIG. 4 and 500 of FIG. 5.

In at least one embodiment, a mathematical minimization method, for example a Least Squares minimization, is used to replace the steps 520 to 590 to find the correspondence between a color C_{IN} and its best color pair replacement C_{Axmin}, C_{Bxmin}.

In at least one embodiment, an additional step is added between steps 520 and 530 to check that the triplet R_{IN}G_{IN}B_{IN} spatially belongs to a subset of the image that we want to process, for example belonging to a region in the image having the highest ability to mask artefacts. Such a region or mask can be given by for example a spatio-temporal just noticeable difference (JND) map, a motion field, a saliency map, etc. If the triplet R_{IN}G_{IN}B_{IN} does not belong to this region or mask, no color pair replacement will be considered for this color.

In at least one embodiment, the triplets {R_{IN}G_{IN}B_{IN}} are ordered according to their consumed energy so that the triplets are processed in decreasing order from the highest consuming to the lowest consuming ones. In such case, a threshold might be defined corresponding to a global energy reduction to achieve. When this threshold is reached for a given number of triplets processed, the global process is stopped. Other ordering criteria may be defined, such as determining on a display which are the RGB combinations which consume energy and can be replaced with maximum effect. A map in the color space can be built storing the replacement power ratio

$${R}_{p} = \frac{P ( {C}_{IN} )}{P ( {C}_{Axmin} ) + P ( {C}_{Bxmin} )}$$

and the set of colors is sorted by decreasing Rₚ before the replacement is made for image pixels. Other examples of ordering would be to make it depend on the distance between the input color and the replacement colors, or to select first the RGB value at the limit of the gamut, or to select according to decreasing saturation values.

FIG. 6 illustrates an example of process for establishing the pair candidates of alternating complementary colors according to a second embodiment in a color space providing color transforms and inverse color transforms. The process 600 is for example implemented by a processor 101 of the device 100 of FIG. 1 and corresponds to the step 420 of FIG. 4. The difference with the first embodiment is that the operations are performed in a color space providing color transforms and inverse color transforms. Examples of such color spaces are the CIE XYZ color space used herein, or the OKLab color space.

When using CIE XYZ, a color is defined by a triplet of coordinates in the XYZ space where Y is the luminance, Z is quasi-equal to B, and X is a mix of the three RGB curves. A compression/expansion transform is conventionally applied (also named “applying a gamma” or “companding”), i.e., elevating each RGB value to the power of a gamma value, which is display dependent, not illustrated in the figure. A forward color transform [symbol] (RGB) then allows to compute XYZ coordinates from RGB values and an inverse color transform [symbol] (XYZ) apply inverse operations, i.e., allows to compute the RGB values from XYZ coordinates, also followed by the inverse companding operation.

The process is operated on an input pixel p whose color is represented by the input color triplet R_{IN}G_{IN}B_{IN}. In step 610, the processor determines the energy consumption [symbol] _{IN} for the input color triplet according to a selected color power consumption model. In step 620, the processor determines the color point C_{IN} corresponding to the R_{IN}G_{IN}B_{IN} triplet within the gamut {G} of the color space {C}. In step 630, the processor applies a RGB to XYZ forward color transform on the R_{IN}G_{IN}B_{IN} triplet to obtain the X_{IN}Y_{IN}Z_{IN} coordinates in the XYZ space. The forward color transform is display dependent. An example of color transform is the sRGBtoXYZ matrix where the white point corresponds to the CIE standard illuminant D65. In step 640, the processor samples the color space {C} within the gamut {G} to determine a set of candidate colors {C_{A}} for the temporally successive pixels. The coordinates X_{A}Y_{A}Z_{A} of candidate colors may verify certain conditions. In a first variant, X_{A}=Y_{A}=Z_{A} so that the chosen C_{A} color is part of the grey ramp (i.e., a greyscale color). In a second variant, one of the X_{A} or Y_{A} or Z_{A} coordinates is set to zero so that the chosen C_{A} color is a saturated color. In a third variant, Y_{A}=Y_{IN} so that the chosen C_{A} color has no or minimal variation in luminance compared to the input color, thus getting closer to equiluminance. In a fourth variant, Y_{A}=α·Y_{IN} with α∈[0.8, 1.2] so that it minimizes variations in luminance compared to the input color (quasi-equiluminance).

Then the process is iterated over the steps 650 to 690 to build the set of candidate color pairs for each color of the set of candidate colors {C_{A}} for the temporally successive pixels. In step 650, the processor determines, for a selected color C_{A}, a second color C_{B} of coordinates X_{B}Y_{B}Z_{B} such that the color is symmetrical to C_{A} with regard to C_{IN} in the color space. In the selected color space, this is simply done using the following computation:

$$\{ \text{} \begin{matrix}{X}_{B} = 2 \cdot {X}_{IN} - {X}_{A} \\ {Y}_{B} = 2 \cdot {Y}_{IN} - {Y}_{A} \\ {Z}_{B} = 2 \cdot {Z}_{IN} - {Z}_{A}\end{matrix} \text{}$$

In step 655, the processor verifies that the color C_{B} is comprised in the gamut {G} of the color space {C}. Indeed, if the color is out of the gamut range, it cannot be displayed so that the combination of C_{A} and C_{B} sub-pulses will not be perceptually the same as a pulse of color C_{IN}. If the color is out of the gamut, the iteration stops for the selected value of C_{A} since it does not lead to a correct pair of colors for the temporally successive pixels. In this case, the process starts again the iteration with step 650 for the next value of C_{A} if any is remaining in the set.

In step 660, the processor determines the corresponding triplets R_{A}G_{A}B_{A}, R_{B}G_{B}B_{B} for the pair of colors C_{A}, C_{B} by applying the inverse transform: R_{A}G_{A}B_{A}= [symbol] (X_{A}Y_{A}Z_{A}) and R_{B}G_{B}B_{B}= [symbol] (X_{B}Y_{B}Z_{B}). In step 670, the processor determines the energy consumption of the combination of temporally successive pixels of colors C_{A}, C_{B}. In embodiments using frame doubling, this is evaluated each for half a period using the selected color power consumption model as:

$${𝒫}_{AB} = \frac{1}{2} 𝒫 ( {R}_{A} {G}_{A} {B}_{A} ) + \frac{1}{2} 𝒫 ( {R}_{B} {G}_{B} {B}_{B} )$$

In step 680, the processor verifies that [symbol] _{AB}< [symbol] _{IN}. Indeed, a candidate pair of colors for the temporally successive pixels is considered only when it brings some energy reduction. If it is not the case, then the candidate pair is discarded, and the process starts again the iteration with step 650 for the next value of C_{A} if any is remaining in the set. In embodiments using frame doubling, the test of step 680 can also be formulated as follows: [symbol] _{A}+ [symbol] _{B}<2· [symbol] _{IN} with [symbol] _{A}, [symbol] _{B}, [symbol] _{IN} respectively representing the energy of a pixel of color C_{A}, C_{B}, C_{IN}. In other words, a candidate pair of alternating complementary colors is considered when the sum of the energies of the pair of alternating complementary colors is lower than twice the energy of the input color, in embodiments using frame doubling.

In step 690, the processor adds the candidate pair C_{A}, C_{B} to the set of candidate pairs {C_{AB}}.

In step 430, the processor selects one of the candidate pairs C_{A}, C_{B} as the pair of colors of temporally successive pixels to replace the pixel of color C_{IN}. The multiple variations and embodiments described in the context of FIG. 5 for the selection of one pair from the set of candidate pairs also apply here.

A third embodiment is based on the same process as described in FIG. 6 with the difference that the selected color space is a uniform color space (for example: CIELab, IPT, OKLab, or others). Uniform color spaces are built such that the same geometrical distance (2-distance) anywhere in the color space reflects the same amount of perceived color difference. The CIELab color space is selected for the description below. In this color space, a color is expressed as three values: L for perceptual lightness and a and b for the four unique colors opponents of human vision: red and green, blue and yellow. For this embodiment, some variations are required to adapt some of the steps of the process 600 to the uniform color space. In step 630, the processor applies a forward color transform RGB to CIELab on the R_{IN}G_{IN}B_{IN} triplet to obtain the L_{IN}a_{IN}b_{IN} coordinates in the CIELab color space. The forward color transform conventionally comprises a gamma operation. In step 640, the processor samples the color space {C} within the gamut {G} to determine a set of candidate colors {C_{A}} of the temporally successive pixels. The coordinates L_{A}a_{A}b_{A} of candidate colors may verify certain conditions. In a first variant, a_{A}=b_{A} so that the chosen C_{A} color is part of the grey ramp (i.e., a greyscale color). In a second variant, set L_{A}a_{A}b_{A} so that its cylindrical version L_{A}C_{A}h_{A} as the same luminance and hue as L_{IN}a_{IN}b_{IN} but maximum chroma. In a third variant, L_{A}−L_{IN} so that the chosen C_{A} color has no or minimal variation in luminance compared to the input color, thus getting closer to equiluminance. In a fourth variant, L_{A}=α·L_{IN} with α∈[0.8, 1.2] so that to minimize variations in luminance compared to the input color (quasi-equiluminance). In step 650, the processor determines, for a selected color C_{A}, a second color C_{B} of coordinates L_{B}a_{B}b_{B} such that the color is symmetrical to C_{A} with regard to C_{IN}. In the uniform color space, this is simply done using the following computation:

$$\{ \text{} \begin{matrix}{L}_{B} = 2 \cdot {L}_{IN} - {L}_{A} \\ {a}_{B} = 2 \cdot {a}_{IN} - {a}_{A} \\ {b}_{B} = 2 \cdot {b}_{IN} - {b}_{A}\end{matrix}$$

In step 660, the processor determines the corresponding triplets R_{A}G_{A}B_{A}, R_{B}G_{B}B_{B} for the pair of colors C_{A}, C_{B} by applying the inverse transform: R_{A}G_{A}B_{A}= [symbol] (X_{A}Y_{A}Z_{A}) and R_{B}G_{B}B_{B}= [symbol] (X_{B}Y_{B}Z_{B}). The other steps of process 600 are identical. The multiple variations and embodiments described in the context of FIG. 5 for the selection of one pair from the set of candidate pairs also apply to the third embodiment.

FIG. 7 illustrates an example of pixel replacement by temporally successive pixels of alternating complementary colors according to an embodiment based on frame doubling. In this embodiment, the display frequency is doubled compared to the original image frequency. For example, if the sequence of images was intended to be displayed at 50 Hz, the display frequency is doubled to display a sequence of modified images at 100 Hz, allowing to replace the original pixels by alternating complementary color pixels and thus allowing to reduce the energy consumption of the display while preserving the quality of experience.

In the figure, the line 700 represents a temporal sequence of original (i.e., before being modified) images to be displayed, here comprising three images 701, 702, and 703. These images are displayed respectively during the periods t1, t2 and t3. In the example of a 50 Hz display frequency, the length of these periods is 20 ms. For the sake of simplicity of the drawings, the images 701, 702, and 703 are composed of 2 rows of three pixels each. The pixels are represented here by numbered blocks. The number identifies the pixel color with reference to the colors introduced in FIG. 3. For example, the first line of image 701 is composed of pixels 301, 302, and 303. Therefore, the first pixel 301 of this line is brown with RGB value of 147, 107, 0, the second pixel 302 is navy blue with RGB values of 127, 141, 141, and the third pixel 303 is dark magenta with RGB values of 82, 108, 160. In the second line, the three pixels are respectively navy blue, brown and dark magenta.

The line 710 represents a temporal sequence of the modified image to be displayed, comprising images 711, 712, 713, 714, and 715. Each of these images is displayed for half the duration compared to the line 700, in correspondence with the frequency doubling. Therefore, the initial 50 Hz display frequency for line 700 is doubled to 100 Hz in line 710 and the periods t1A, t1B, t2A, t2B and t3A are 10 ms long. Compared to line 700, a double number of images are displayed in line 710. This allows to insert intermediate images to introduce the alternating complementary color pixels, thus allowing to reduce the energy consumption when displaying the image.

For each pixel of the original image 701, a color pair is determined as described earlier in relation to FIG. 5 or 6. This color pair is used to define a first pixel of the first color of the color pair for image 711 and a second pixel of the second color for image 712, the two pixels being displayed successively at the double frequency of the expected display of pixel 301. For example, the brown pixel 301 of image 701 is replaced by a green pixel 301A in image 711 and a red pixel 301B in image 712. These replacement red and green pixels are displayed half the time of the original brown pixel. As described previously, thanks to the human visual system, these pixels will be perceived by a human viewer as having the brown color of pixel 301, while requiring less energy for their display.

The frame doubling mechanism for pixel replacement by alternating complementary color pixels has been presented in FIG. 7 when applied to a sequence of images, in other words, a video. However, the same principle applies when displaying a single static image (e.g., text edition application on a computer screen content, configuration screen on a tablet, email application on a smartphone, static image on an advertisement screen, etc). In this case, the FIG. 7 would be restricted to the elements related to image 701 (the single image to be displayed) and the images 711 and 712. Instead of conventionally displaying the image 701 at a given frequency, the images 711 and 712 would be displayed in alternance at a double frequency.

FIG. 8 illustrates an example of pixel replacement by temporally successive pixels of alternating complementary colors according to an embodiment based on frame skipping. This method may be used for example when it is not possible to double the display frequency. It is based on skipping one image out of two in a sequence of images, deriving color pairs from the colors of the remaining images and then replacing the original sequence of images by a sequence of images comprising successively an image with pixels of the first color of the color pair and an image with pixels of the second color of the color pair. Another way to describe this embodiment is to replace a pair of temporally successive pixels, at the same position in two successive images, by another pair of temporally successive pixels, at the same position in two successive images, the second pair being perceptually similar to the first one but requiring less energy to display. Colors of the new pair are chosen based on the colors of the first pixel of the first pair.

This is illustrated in the figure where the line 800 shows a temporal sequence of the original images 801, 802, 803, 804, and 805. The line 810 illustrates the temporal succession of the reduced energy images 811, 812, 813, 814, and 815 to be displayed. Images 811 and 812 are obtained from original image 801 as described above, by determining color pairs being perceptually similar to the color of the original image 801 but requiring reduced energy for display. For example, the color 301 of the first pixel p₁ of the first line of image 801 is processed as described above to determine the color pair 301A, 301B. These colors are respectively used in the first image 811 and the second image 812 of the sequence. The images 802 and 804 are discarded so that the original pixels of these images (for example the first pixel p₂ of the first line) are not considered at all in the image to be displayed.

In this embodiment, the constraint related to the reduction of the energy required for display is here verified by determining that the energy required to display the temporally successive pixels p_{A} and p_{B} of colors c_{A} and c_{B} is lower than the energy required to display the original pixel p of color c_{IN} and the skipped pixel. Indeed, in such embodiment, the temporally successive pixels p_{A} and p_{B} are no more of half size than the original but replace two original pixels of same duration: the original pixel p₁ and the skipped pixel p₂.

FIG. 9 illustrates an example of pixel replacement by temporally successive pixels of alternating complementary colors according to an embodiment based on frame averaging. This method may be used for example when it is not possible to double the display frequency. It is based on averaging the colors for the pixels of two successive frames and replacing these frames by two frames comprising alternating complementary colors determined based on the averaged colors. Another way to describe this embodiment is to replace a pair of temporally successive pixels, at the same position in two successive images, by another pair of temporally successive pixels, at the same position in two successive images, the second pair being perceptually similar to the first one but requiring less energy to display. Colors of the new pair are chosen based on an average of the colors of the first pair. Compared to the frame skipping technique discussed in relation with FIG. 8, this allows to take into account all pixels, of all images of the original sequence of images. As a result, the modified images 901 and 902 are depending on the images 801 and 802 of FIG. 8.

The line 900 illustrates the temporal succession of the reduced energy images 901, 902, 903, 904, 905 obtained by processing the images 801, 802, 803, 804, 805 of FIG. 8. For this method, the processor first averages the colors of pixels from the image 801 and 802 of FIG. 8. For example, the first pixel p₁ (of color 301) of the first line of the first image is averaged with the first pixel p₂ (of color 302) of the first line of the second image. In a preferred embodiment, averaging is performed by converting the pixels color values RGB in a uniform color space, CIELab for example, computing the average of the two pixels and converting back the result to the RGB color space. This leads to an average color value 312 for this first pixel of the first line. A pair of alternating complementary colors c_{A} and c_{B} of respective values 312A and 312B are determined based on the average color value 312 using the same methods as described above. These colors are used for the first pixel p_{A} of the first line in the first image 901 and the first pixel p_{B} of the first line in the second image 902.

In this embodiment, the constraint related to the reduction of the energy required for display is here verified by determining that the energy required to display the temporally successive pixels p_{A} and p_{B} of colors c_{A} and c_{B} is lower than the energy required to display the original pair of pixels p₁ and p₂. Indeed, in such embodiment, the temporally successive pixels p_{A} and p_{B} are no more of half size than the original but replace two original pixels of same duration.

Both the frame skipping and the frame averaging methods may lead to a loss of a part of the original signal that may affect the visual quality of the modified image since the spatial or temporal resolution is affected. Some spatial or temporal filtering may be used to improve the quality of the signal.

One improvement would be to apply the alternating complementary color process only on uniform regions and let the images unchanged where there are high spatial frequencies (i.e., edges). In at least one embodiment, for each pair of successive images, the processor detects edges with a contour filter (Canny edge detector, difference of gaussians for example), possibly dilates these contours and saves the contour zones as masks (M₁, M₂). Two parameters are needed: the dilation size and the threshold above/below which the masks are binarized. Then, the masks (M₁, M₂) are inverted to obtain non-contour zones: (M̅₁, M̅₂) and the common non-contour zones M̅₁₂=\hat{M}₁∩M̅₂. When non-contour zones are present in both images of the pair (M̅₁₂=1), the processor averages the two zones into a single image of color

$$( {C}_{12} = \frac{{C}_{1} + {C}_{2}}{2} ) ,$$

with C₁ and C₂ being the colors of the two zones. The process then duplicates the average image to form a pair, processes colors as described above on this pair to obtain a pair of alternating complementary colors (C_{A}, C_{B}) based on C₁₂ and adds up back the saved contours on each image of the initial image pair to (C_{A}, C_{B}). The resulting colors C₃, C₄ for the two images are then defined as:

$$\{ \text{} \begin{matrix}if ( {M}_{1} ) {C}_{3} = {C}_{1} & if ( {\overline{M}}_{1} ) {C}_{3} = {C}_{A} \\ if ( {M}_{2} ) {C}_{4} = {C}_{2} & if ( {\overline{M}}_{2} ) {C}_{4} = {C}_{B}\end{matrix} \text{}$$

As a result, ACC is applied only on more uniform regions. The temporal information from (C₁, C₂) is kept and directly transferred to (C₃, C₄) sub-frames based on high spatial frequencies.

The above enhancing technique can be applied in the three temporal modes comprising frequency doubling, frame skipping and frame averaging.

The prediction of regions of interest (for example using eye tracking, attention modelling, metadata-based, etc.) can also be used to define the regions to be kept as the original and the regions where the ACC process should be applied as shown in Table 2.

TABLE 2

| | Action |
|---|---|
| Contour or Region of interest | (C₁, C₂) kept and directly transferred to (C₃, C₄) |
| Non-Contour or Not Region of interest | $( {C}_{1} , {C}_{2} ) averaged into ( {C}_{12} = \frac{{C}_{1} + {C}_{2}}{2} ) and then$ |
| | ACC processed to (C_{A}, C_{B}) on the basis of C₁₂ |

FIG. 10 illustrates an example of process for generating a look-up table for alternating complementary colors according to embodiments and an example of process for modifying an image using the look-up table according to embodiments. These processes are implemented based on embodiments described above.

The process 1000 aims at generating the look-up table of alternating complementary colors. The step 1010 is iterated multiple times. In at least one embodiment, the iterations are done over all possible colors in the color gamut. In at least one other embodiment, the iterations are done over a sub-sampled color space only. In at least one other embodiment, the iterations are done over all colors of a predetermined set of images. Other embodiments may use other subset of colors. It comprises the steps 1020 to 1050. In step 1020, an input color is obtained. In step 1030, a set of pairs of alternating complementary colors corresponding to the input color is determined, for example using one of the embodiments described above. In step 1040, one of the pair of the set is selected, for example the pair providing the best energy performance. In step 1050, the association between the input color and the pair of alternating complementary colors is stored in a look-up table. At the end of process 1000, the look-up table comprises a set of associations between input colors and pairs of alternating complementary colors.

The process 1001 aims at modifying an image using the look-up table. In step 1060, an input image is obtained. In step 1070, a pixel is selected and, in step 1080, the pair of temporally alternating complementary colors corresponding to the color of the pixel is obtained from the look-up table. In step 1090, the colors of a pair of temporally successive pixels are set to the pair of alternating complementary colors. The steps 1070, 1080 and 1090 are then iterated over all the pairs of adjacent pixels.

FIG. 11 illustrates two examples of deployment for the alternating complementary color process according to embodiments. In at least one embodiment, the device 1101 is a display device such as the one described in FIG. 1. In this case, the processor 101 of the device 1101 is configured to obtain an input image or video 1100 and displays it on the display unit 103 of FIG. 1 after being processed by the ACC process as described above. In other words, the processor 101 of the device 1101 is configured to obtain an input image or video 1100 and determine a modified image or video to be displayed using spatially alternating complementary colors obtained by using a look-up table LUT that results into an image providing reduced energy consumption of the display device when compared to displaying the original input image. The look-up table may be obtained from a data provider through a communication network and/or from an internal memory of the device. The image or video 1100 may be obtained from a data provider through a communication network, from an internal memory of the device, stored for example after being captured by an input unit. Typical examples of devices 1101 are smartphones, tablets, laptops, external monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 1101 while still conforming with the principles of the disclosure.

In at least one embodiment, the device 1102 does not include a display unit but prepares data for display so that another device 1103, such as a screen, can perform the display. In this case, the processor of the device implements the ACC process described herein and generates a new image or video 1110 that is perceptually similar to the original video but will require less energy when being displayed. This modified video is then provided to a display device 1103 for being presented to a human viewer. Example of such devices 1102 are set top boxes, media players, desktop computers, encoders, decoders, servers, computing grids, cloud computers, etc.

Light production in display devices, including mobile phones and televisions, is costly. Reduction of the amount of light produced is desirable, as this helps to reduce the amount of energy necessary to operate the display. The advantage of this is two-fold: less pressure on the climate, and longer battery life in mobile devices. Relative to other methods that aim to reduce energy consumption for the same reasons, the proposed method, by means of its construction, guarantees that the light emitted by each pixel is produced with a combination of two light pulses minimizing energy consumption in average. This is meant to be more versatile and thus more efficient than acting on single light pulse of a single pixel.

However, the introduction of the techniques described above may lead to the perception of a flicker that can lessen the quality of experience. Flicker is perceived when a source of light shines unsteadily or varies rapidly in brightness. This is the case of displays when using the alternating complementary colors process method described above. A first technique for reducing flicker is to apply the constraint of equiluminance in the choice of the complementary colors. In addition, since the temporal contrast sensitivity drops down with higher frequencies, this also allows for an attenuation of the perceived flicker. However, some perception may remain, that can be further attenuated through the embodiments described below.

In at least one embodiment, the flicker is reduced by relying on spatial averaging of colors at eye level (perceptual averaging). This may be done by processing colors using blocks (i.e., regions of the image covering a certain area) of inverted polarities. The notion of opposed polarities should be understood herein as choosing, in the pair of alternating complementary colors, “C_{A} then C_{B}” by opposition to “C_{B} then C_{A}”. The flicker will be naturally attenuated by a spatial average done by the visual perception, between opposed polarities between the blocks. The color temporal average is identical as well as the energy reduction, but the flicker effect is diminished. Therefore, depending on the order of choice between C_{A} and C_{B} (in other words “C_{A} then C_{B}” or “C_{B} then C_{A}”), the two colors do not exactly play the same role in the complementary pair. Using different choice order for adjacent blocks will help to reshape the flicker. The choice is, for instance, using C_{A} for a first block of pixels on a first image and C_{B} on the complementary second image of this first block, and using C_{B} for a second (neighboring or adjacent) block of pixels on a first image and C_{A} on the complementary second image of this adjacent block. In this case the flicker will be reduced thanks to the visual spatial averaging between neighboring blocks having opposite polarities.

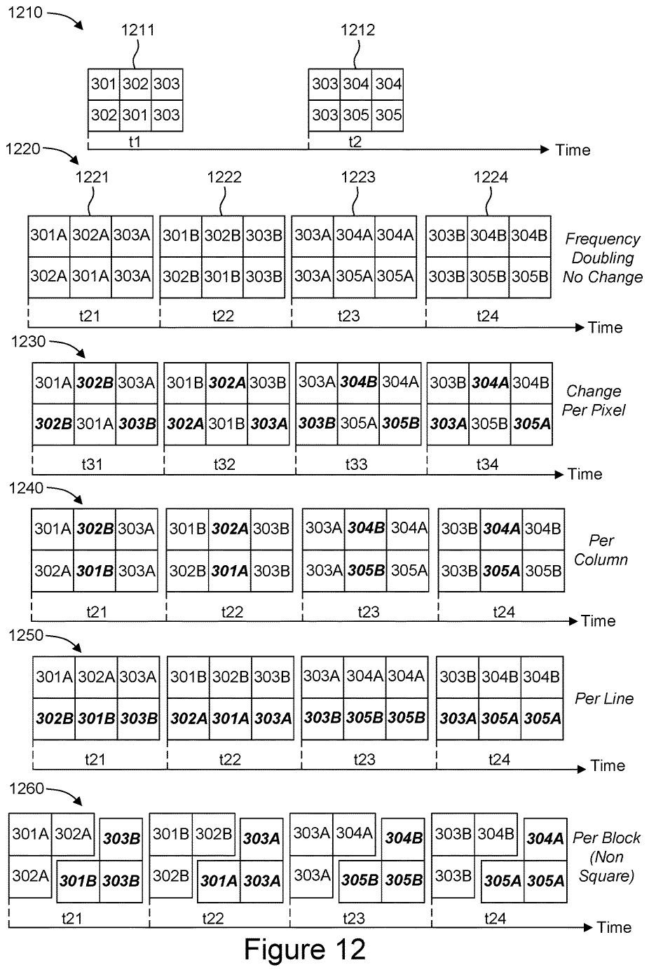

FIG. 12 illustrates examples of pixel replacement by alternating complementary color pixels according to variant embodiments based on frequency doubling and using opposed polarities for adjacent blocks. These examples are based on the frequency doubling embodiment, but the principle of opposed polarities for adjacent blocks applies similarly to the frame skipping and frame averaging embodiments with the difference that an intermediate image exists between image 1211 and 1212 and after image 1212 (like images 1222 and 1224). In a frame skipping embodiments, the pixels of these additional images will be skipped, as described above. In a frame averaging embodiments, the pixels of these additional images will be averaged with the pixels of the images 1211 and 1212 as described above. Moreover, the principle of opposed polarities may be used for different sizes: for example, from 1×1 pixel to N×M pixels, N or M to be defined, fixed or variable, N or M being up to a column or row.

Similar to FIG. 7, the line 1210 represents the succession of images 1211 and 1212, each of them composed of two lines of three pixels to be displayed and the numbers 301, 302, 303, 304, 305 identifying the colors of the different pixels. Similar to FIG. 7, the line 1220 represents an example embodiment using the frequency doubling with the alternating complementary colors but without using opposed polarities: images 1221 and 1223 use the first color of the pair of colors (identified with the suffix A on the figure) while images 1222 and 1224 use the second color of the pair of colors (identified with the suffix B on the figure). These first two lines are presented here for the sake of comparison with lines 1230 to 1260 that represent different variant embodiments using opposed polarities for various block sizes and shapes. For each of these lines 1230 to 1260, the four images are the succession of images to be displayed instead of the succession of images 1211 and 1212. The changes with regards to the embodiment using the frequency doubling ACC method without opposed polarities of line 1220 are represented by italic emphasis of numbers.

In a first variant embodiment illustrated in line 1230, the block size is 1×1 pixel so that the opposed polarities occur for each other pixel. In addition, each line starts with opposed polarity with regards to the previous line, resulting into a checkerboard pattern of opposed polarities. This is the variant that provides the best results as patterning is at the finest size and is the same in both directions, vertical and horizontal.

In another variant embodiment illustrated in line 1240, the block size is one column of the image. In another variant embodiment illustrated in line 1250, the block size is one line of the image.

In another variant embodiment, the block size is a non-square shape. In another variant embodiment, the block size is a non-rectangular shape. This is illustrated in line 1260 by using a “L-shape” but any other shape may be used.

In another variant embodiment, the block size depends on the content of the image: uniform areas comprising small blocks (for example as small as 1×1 pixel) and more structured areas comprising larger blocks.

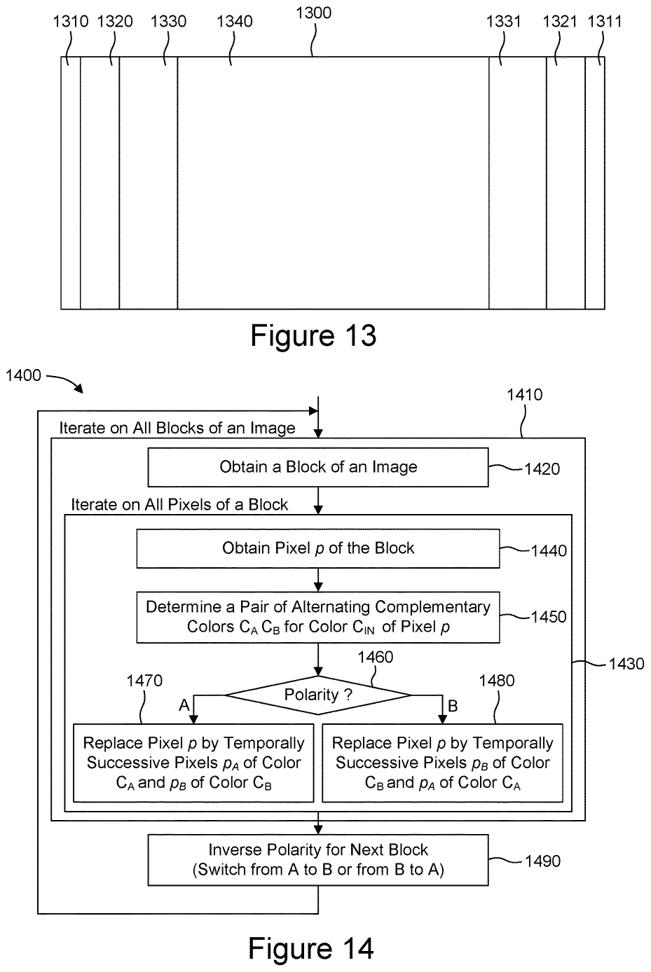

FIG. 13 illustrates examples of blocks for pixel replacement by alternating complementary color pixels according to a variant embodiment using opposed polarities for adjacent blocks where the block size is non-homogeneous. In this case, the image 1300 is decomposed in blocks with smaller size on the periphery where peripheral vision may occur, more sensitive to flicker. More particularly, the blocks 1310 and 1311 at the extreme left and right borders of the image use a 1×1 pixel block size for the opposed polarities (thus similar to the first variant of FIG. 11), while the size for blocks 1320 and 1321 is 2×2, the size for blocks 1330 and 1331 is 4×4 and the block size for the central area 1340 of the image is 8×8. Although the picture illustrates block size variations horizontally, the same principle applies vertically, thus resulting into a similar figure rotated by 90°. The two block size variations may be combined, resulting into concentric blocks of different sizes.

FIG. 14 illustrates an example of process for reducing the energy consumption for a pixel of an image using alternating complementary colors of opposed polarities according to embodiments. The process 1400 is for example implemented by a processor 101 of the device 100 of FIG. 1. The process 1400 takes as input an image comprising a set of blocks defined according to one of the embodiments or variants exposed above. The step 1410 may be iterated over all the blocks composing the input image. This step 1410 comprises the steps 1420 and 1430. In step 1420, the processor obtains a block of an image. Then the step 1430 is iterated over pixels of the block.

In step 1440, a pixel p having the color c_{IN} is obtained. In step 1450, the processor determines a pair of alternating complementary colors c_{A}, c_{B} corresponding to the color c_{IN} of the pixel p. This is done using one the embodiments described above, for example using a look-up table that associates a color to a corresponding pair of alternating complementary colors.

In step 1460, a polarity information is checked. The polarity is represented by a piece of information common for the whole process 1400, the information indicating at any time whether the polarity is A or B. It may be implemented by a simple Boolean variable (for example true meaning that the polarity is A and false meaning that the polarity is B) or any other type of variable (for example: an enumeration, an integer, a string, etc.). The polarity information is set to a default value when starting the process 1400 (for example A as illustrated in lines 1230 to 1260 of FIG. 12). As a result of this check, when the polarity information is equal to A, the processor executes the step 1470 and replaces the pixel p by a pair of temporally successive pixels p_{A} and p_{B}, the color of p_{A} being set to C_{A} and the color of p_{B} being set to C_{B}. In the other case, when the polarity information is equal to B, the processor executes the step 1480 and replaces the pixel p by a pair of temporally successive pixels p_{B} and p_{A}, the color of p_{B} being set to C_{B} and the color of p_{A} being set to C_{A}. Once all pixels of the block have been replaced by successive pixels of alternating complementary colors, the processor, in step 1490, inverses the polarity before processing the next block. In other words, when the polarity information was A, it becomes B and vice versa. When the implementation of the polarity information is based on a Boolean value, this is simple done by inverting (i.e., taking the two-complement) the value of the variable. The process iterates again on the next block until all the blocks have been treated.

When all blocks have been treated, the processor can display the successive images using one of the temporal techniques chosen between frequency doubling, frame skipping or frame averaging. This allows, as described in the variant embodiment illustrated in FIG. 12, to provide opposed polarities for the alternating complementary colors and thus to reduce the perception of the flicker by a human observer.

Thanks to the embodiments described above, the selection of alternating complementary colors will be more efficient for a given display: flicker and artefacts will be reduced and, so the principle of successive pixels of alternating complementary colors is therefore applicable on more use cases and system configurations.

In addition, the reduction of flicker perception can allow a stronger pixel modulation, with possibly, a modulation in luminance to some degree. This means that more freedom could be provided in the determination of the set of color pairs, leading to a larger set of pairs with color pairs providing a higher reduction in energy consumption. Selecting such pairs would allow to further reduce the energy consumption.

Although different embodiments have been described separately, any combination of the embodiments together can be done while respecting the principles of the disclosure.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

Additionally, the terms “image” and “frame” are used herein interchangeably and are both used to represent a set of pixels, for example arranged in a two-dimensional array. A sequence of multiple images or frames arranged according to a temporal order is conventionally named a “video”.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method comprising iterating over pixels of an image of a video, wherein an iteration comprises, for a pixel:
obtaining a pair of alternating complementary colors based on the color of the pixel;
replacing the pixel of the image of the video by a pair of temporally successive pixels based on polarity information, wherein when the polarity information has a first value, setting the color of the first temporally successive pixel to the first color of the pair of alternating complementary colors and setting the color of the second temporally successive pixel to the second color of the pair of alternating complementary colors, else setting the color of the first temporally successive pixel to the second color of the pair of alternating complementary colors and setting the color of the second temporally successive pixel to the first color of the pair of alternating complementary colors; and
inverting the polarity information for a next pixel.

2. The method of claim 1, wherein the pair of alternating complementary colors is obtained from a look-up table based on the color of the pixel, the look-up table comprising a set of associations between a color and pair of alternating complementary colors and wherein an average color of the pair of alternating complementary colors is perceptually identical to the color and a sum of energies of the pair of alternating complementary colors is lower than twice the energy of the color.

3. The method of claim 2, wherein the look-up table is built by iterating over a plurality of possible values of an input color.

4. The method of claim 3, wherein the look-up table is built by selecting a color value for a first color of the pair of alternating complementary colors according to a selection criterion and determining a second color of the pair of alternating complementary colors based on the selected first color value so that an average color of the pair of alternating complementary colors is perceptually similar to an input color and a sum of the energies of the pair of alternating complementary colors is lower than twice the energy of the input color.

5. The method of claim 4, wherein the pair of alternating complementary color is selected from a set of pairs of alternating complementary colors, wherein the set is obtained by multiple iterations over a set of color values for the first color of the pair and further comprising selecting the pair having the lowest energy.

6. The method of claim 5, wherein the selection criterion is based on a maximal color distance from the input color.

7. The method of claim 5, wherein the selection criterion is that the first color is a saturated color.

8. The method of claim 5, wherein the selection criterion is that the first color is a greyscale color.

9. The method of claim 5, wherein the selection criterion is that the first color has the same luminance as the input color.

10. The method of claim 4, wherein the color space is a XYZ color space or a uniform color space and wherein the second color of the pair of alternating complementary colors is selected to be symmetrical to the first color of the pair of alternating complementary colors with regard to the input color.

11-18. (canceled)

19. The method of claim 1, further comprising displaying the temporally successive pixels using frequency doubling so that the temporally successive pixels have half duration compared to pixels of the image of the video.

20. The method of claim 1, wherein the temporally successive pixels are displayed using frame skipping.

21. The method of claim 1, wherein the temporally successive pixels are displayed using frame averaging and wherein the pair of alternating complementary colors is selected based on an average color between a color of a pixel of a first frame and a color of a pixel of a second frame.

22. A device comprising one or more processors configured to iterate over pixels of an image of a video, wherein an iteration comprises, for a pixel:
obtaining a pair of alternating complementary colors based on the color of the pixel;
replacing the pixel of the image of the video by a pair of temporally successive pixels based on polarity information, wherein when the polarity information has a first value, setting the color of the first temporally successive pixel to the first color of the pair of alternating complementary colors and setting the color of the second temporally successive pixel to the second color of the pair of alternating complementary colors, else setting the color of the first temporally successive pixel to the second color of the pair of alternating complementary colors and setting the color of the second temporally successive pixel to the first color of the pair of alternating complementary colors; and
inverting the polarity information for a next pixel.

23. The device of claim 22, wherein the pair of alternating complementary colors is obtained from a look-up table based on the color of the pixel, the look-up table comprising a set of associations between a color and pair of alternating complementary colors and wherein an average color of the pair of alternating complementary colors is perceptually identical to the color and a sum of energies of the pair of alternating complementary colors is lower than twice the energy of the color.

24. The device of claim 23, wherein the look-up table is built by iterating over a plurality of possible values of an input color.

25. The device of claim 24, wherein the look-up table is built by selecting a color value for a first color of the pair of alternating complementary colors according to a selection criterion and determining a second color of the pair of alternating complementary colors based on the selected first color value so that an average color of the pair of alternating complementary colors is perceptually similar to an input color and a sum of the energies of the pair of alternating complementary colors is lower than twice the energy of the input color.

26. The device of claim 25, wherein the pair of alternating complementary color is selected from a set of pairs of alternating complementary colors, wherein the set is obtained by multiple iterations over a set of color values for the first color of the pair and further comprising selecting the pair having the lowest energy.

27-42. (canceled)

43. The device of claim 22, wherein the device is selected in a set comprising smartphones, tablets, laptops, external monitors, head-mounted displays, television set, video projectors, computer screens, vehicles control system, vehicles entertainment systems, advertisement display panels, medical monitors.

44. (canceled)

45. A non-transitory computer readable medium comprising program code instructions for implementing the method of claim 1 when executed by a processor.
